(19) United States
(12) Patent Application Publication
(10) Pub. No.: US 2012/0031910 A1
(43) Pub. Date: Feb. 9, 2012

(54) Buffet Serving System

(76) Inventor: Bart Richard Hogestyn, Oxford, CT (US)

(21) Appl. No.: 13/206,230

(22) Filed: Aug. 9, 2011

Related U.S. Application Data
(60) Provisional application No. 61/371,939, filed on Aug. 9, 2010.

(51) Int. Cl. A47J 27/00

(52) U.S. Cl. 220/573.1

(57) ABSTRACT

A buffet serving system comprising at least one base having a recess therein and a plurality of modules, each receivable in the recess of the base and having an outer surface adapted cooking or serving of food. At least one module is different than the other. Preferably, the number of modules is greater than the number of bases. The modules may consist of a carving board, chafing dish, cooking element or display tray. The modules and bases are connected by risers and can be easily stored on a wheeled cart.

### CROSS-REFERENCE TO RELATED APPLICATIONS

The present application claims the benefit under 35 U.S.C. §119(e) of the U.S. Provisional Patent Application Ser. No. 61/371,939 filed Aug. 9, 2010, the content of which is incorporated herein by reference.

### FIELD OF THE INVENTION

The present invention relates to the field of catering apparatuses, and more particularly to a buffet system comprised of a base having interchangeable serving or preparation modules.

### BACKGROUND OF THE INVENTION

Chafing dishes, also referred to as food pans, steam tables and buffet pans, have long been used in the catering and food service business as a way to present food and keep food warm. Records of chafing dishes being used with charcoal and later canned fuel cells date back to the 17^{th} century. Such chafing dishes typically include a water pan supported by a base structure. A heat source may be placed below the water pan to heat the water in the pan. A chafing dish is supported by the water pan, typically above the level of the water. A lid or cover is provided to cover the chafing dish. It is also possible to utilize the chafing dish and the base structure without the intervening water pan, such as for food dishes served and/or maintained at room temperature.

Although conventional chafing dishes are suitable for serving food and have been in use for a number of years, they have many drawbacks. Problems associated with chafing dishes involve the use of an open flame, the size/weight, food quality, limited menu selection and poor aesthetic quality.

Chafing dishes are typically constructed with a peripheral rim that is either a planar flange having a down-turned outer edge or a planar ledge having and outwardly extending portion which rests on and provides a seal with the water pan in which the chafing dish is placed. In these configurations, steam will often escape from cracks in the seal and accumulate on the surface of any lid or cover placed on the chafing dish. The water then drips on food within in the chafing dish or drips on a user when they remove the lid. The use of steam in chafing dishes overcooks foods, causes excess condensation, and dilutes foods. Crisp foods become soggy.

Leaking steam can also burn the skin of a user when handling, or serving or removing food from the dishes. Additionally, the use of an open flame with a traditional chafing dish presents an increased risk of fire and burns to workers, guests and facilities. The flame is subject to being extinguished by wind and also presents fire code restrictions.

Further, traditional chafing dishes occupy large spaces in serving and storage areas. They are heavy and poorly balanced, which causes short and long term physical injury to those setting up, taking down, transporting, storing, washing and maintaining units. The size and weight also subjects then to damage, especially in storage and transportation situations.

These problems, in turn, limit the variety of menu items. Facilities are restricted to certain foods and serving vessels that are compatible with chafing dishes. The chafing dish is only appropriate for keeping foods warm. A different component is required for cold items. Further, the dishes are often only suitable for maintaining already prepared food and do not allow for the preparation of the food on-site.

Finally, traditional systems have poor visual and aesthetic presentation. Foods served in large open pans within round or rectangular chafing dishes. Canned fuel units are visible and often surrounded by foil to act as wind screen.

It is therefore desired to have a buffet serving system that provides many additional options of serving and preparing buffet foods, such as grilling, sizzling, warming, carving, chilling, sautéing, and stir frying in addition to chafing.

It is also desired to have a buffet serving system with a low profile system of stages that minimize the impression of food service equipment and provide greater variety of configurations and more flexibility than have been previously available to operators.

It is further desired to have a buffet serving system that sets-up and takes down faster and with less effort than a traditional system.

It is also desired to have a buffet serving system that is visually appealing and highlights the appearance of the presentation, the quality and freshness of foods, to create a heightened guest experience.

### SUMMARY OF THE INVENTION

Accordingly, it is an object of the invention to have a buffet serving system that provides interchangeable, drop-in serving and preparation modules as an innovative alternative to the many problems and limiting factors that are associated with serving foods in a buffet setting using the ubiquitous “chafing dish.”

Namely, it is an object of the invention to provide a buffet serving system with interchangeable, drop-in serving and preparation modules that are linkable with other components, storage risers, or caddies from storing serving tools and utensils.

It is another object of the invention to provide a buffet system which allows modules to be easily stacked and also allows the modules to be interconnected into various configurations that are efficient for users.

It is a further object of the invention to provide a buffet serving system that is aesthetically pleasing.

It is another object of the invention to have a buffet serving system including sliding drawers for inserting and removing a heat source.

It is another object of the invention to have a buffet system having chafing modules with vented/no-drip lid.

It is yet another object of the invention to provide a buffet serving system that includes a device for transporting and storing system modules.

These and other objects are achieved through the buffet serving system of the present invention which comprises at least one base having a recess therein and a plurality of modules each receivable in the recess of the base and having an outer surface adapted for at least one of cooking and serving of food wherein at least one of the plurality of modules has a different configuration than the other modules.

In one embodiment, the number of modules is greater than the number of bases.

In some embodiments, at least one of the plurality of modules is thermally conductive. In some of these embodiments, at least one outer surface of the plurality of modules comprises an induction cook top. In other of these embodiments, at least one outer surface of the plurality of modules comprises grates.

In some embodiments, the base further comprises a heat source removably positioned in the recess of the base and below the module receivable in said recess of said base. In some of these embodiments, the heat source is sterno. In other of these embodiments, the heat source is electric. In yet other of these embodiments, the heat source is butane.

In some embodiments, at least one of the plurality of modules is a carving board. In other embodiments, at least one of the plurality of modules is a chafing system comprising a serving pan receivable in a water pan. In some of these embodiments, the chafing system further comprises a hinged lid having a condensation channel therein.

In some embodiments, the base has a side wall having at least one drawer therein for discretely placing a heat source or the like.

In some embodiments, the base has at least one corner, and the system further comprises at least one guard for receiving the corner of the base.

In some embodiments, the above described buffet serving system also comprises at least one riser having a top planar surface with at least one side panel extending therefrom, said side panel having an opening therein. In some of these embodiments, the system includes a storage caddy receivable in the opening of the side panel of the riser.

In some embodiments of the buffet systems, the plurality of modules comprises at least one carving board, at least one chafing system, and at least one cooking element selected from grill, induction top, and sauté cooker. Other preferred embodiments comprise at least one display tray.

In yet other embodiments, the above described buffet serving systems include a cart having wheels for storage and transport of the bases and modules. In some of these embodiments, the system includes at least one protective case for receiving the bases and modules.

### BRIEF DESCRIPTION OF THE DRAWINGS

FIG. 1 is an overview of a base unit according to an embodiment of the invention.

FIG. 2 is an overview of another base unit according to an embodiment of the invention.

FIG. 3 is an overview of a grill module according to an embodiment of the invention.

FIG. 4 is an underside view of a grill module according to an embodiment of the invention.

FIG. 5 is an overview of a grate module according to an embodiment of the invention.

FIG. 6 is an overview of a carving board module according to an embodiment of the invention.

FIG. 7 is an overview of a pan module according to an embodiment of the invention.

FIG. 8 is an exploded view of an assembly of a grill module with a base unit according to an embodiment of the invention.

FIG. 8A illustrates an exploded view of an assembly of tray modules with a grill module and a base unit according to an embodiment of the invention.

FIG. 9 illustrates an overview of an assembly of a grate module with a base unit according to an embodiment of the invention.

FIG. 10 illustrates an exploded view of an assembly of a pan module with a base unit according to an embodiment of the invention.

FIG. 11 illustrates an exploded view of an assembly of a carving board module and a pan module with a base unit according to an embodiment of the invention.

FIG. 12 illustrates an exploded view of an assembly of a base unit with a grill module, a pan module, and a dome module according to an embodiment of the invention.

FIG. 13 illustrates an overview of an assembly of a base unit with a grill module, a pan module, and a dome module according to an embodiment of the invention.

FIG. 14 illustrates an overview of a butane burner module shown in an operating position according to an embodiment of the invention.

FIG. 15 illustrates an overview of a butane burner module shown in a storage position according to an embodiment of the invention.

FIGS. 16 A-C illustrate an overview of the operation of a safety tab according to an embodiment of the invention.

FIG. 17 illustrates an overview of an induction cooktop assembly according to an embodiment of the invention.

FIG. 18 illustrates an exploded view of an assembly of two base units according to an embodiment of the invention.

FIG. 19 illustrates an overview of a wedge riser module according to an embodiment of the invention.

FIG. 20 illustrates an overview of a storage unit according to an embodiment of the invention.

FIG. 21 illustrates an exploded view of a storage assembly according to an embodiment of the invention.

### DETAILED DESCRIPTION OF THE INVENTION

As can be seen from the figures, the present invention provides a low profile system of stages that minimize the impression of food service equipment and highlight the appeal and presence of the food. Specialized components and accessories are combined with multiple-use foundation units to provide greater variety of configurations and more flexibility than have been previously available to operators. It is understood that various features and components shown in the figures can be interchanged among the different embodiments without departing from the essence of the invention. It should be noted that the various components described as rectangular in shape can also be fashioned as square or round without departing from the spirit of the invention.

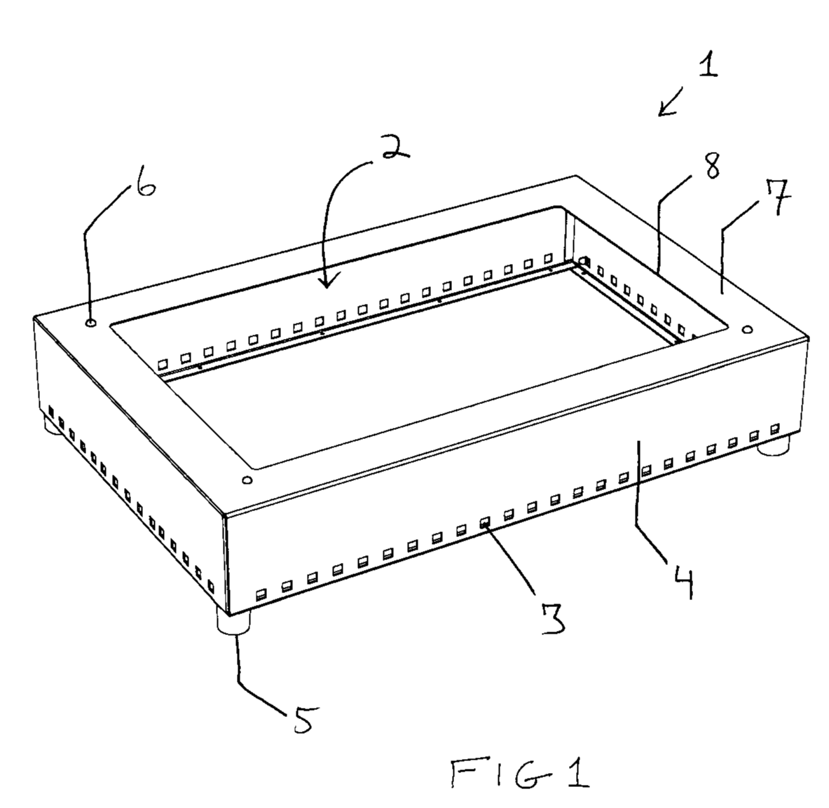

FIG. 1 illustrates an overview of a base unit 1 according to an embodiment of the invention. Base unit 1 is rectangular in shape, and includes a recess 2. Base unit 1 may be made of metal and/or any other heat and/or flame resistant materials known in the art. In some embodiments, base unit 1 may include vents 3 which may be disposed on a side wall 4 of base unit 1. In some embodiments, base unit 1 also includes feet 5 and/or pads 6. In some embodiments, pads 6 are comprised of rubber or another suitable cushioning material. A top surface 7 of base unit 1 has a top opening 8. In some embodiments, pads 6 may be of a height of approximately ¼ inch from top surface 7.

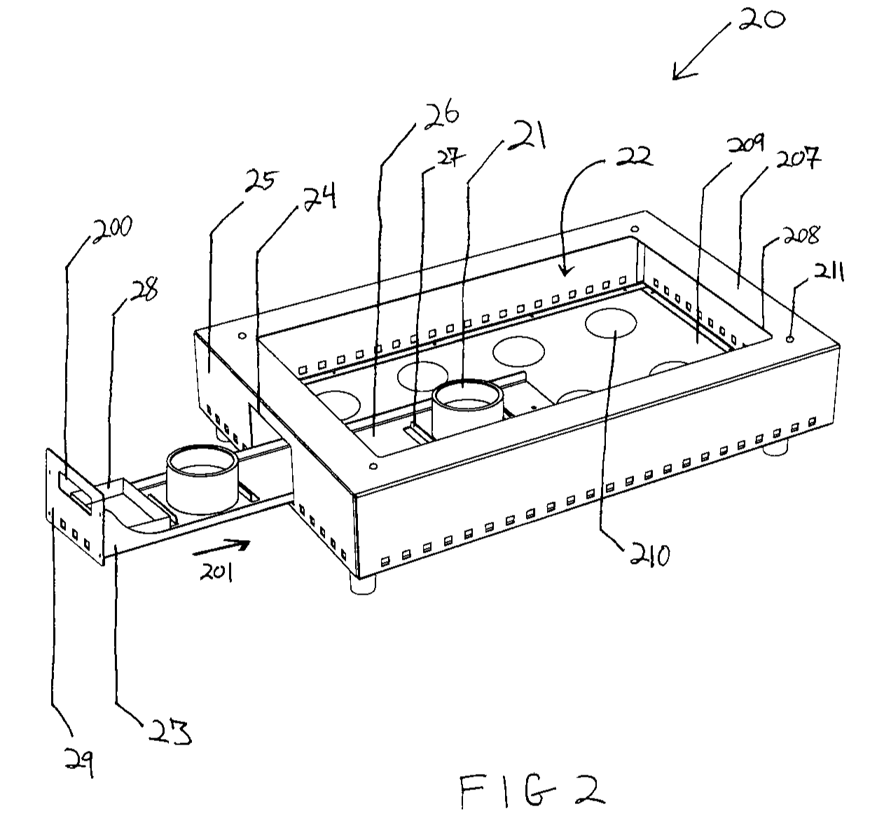

FIG. 2 illustrates an overview of a base unit 20 according to an embodiment of the invention. Base unit 20 is constructed similarly to base unit 1 shown in FIG. 1 except as herein described, and includes pads 211. In some embodiments, heat source 21 is removably or non-removably disposed within recess 22. Heat source 21 may be a disposable chemical flame source such as Sterno™, a non-disposable flame source such as a propane or butane burner (not shown), an electric source such as a resistance coil or induction heating assembly (not shown), or any other suitable heat source. In some embodiments, base unit 20 may include a drawer 23. Drawer 23 may be made of similar materials to base unit 20, or of any other suitable material. Drawer 23 may be slidably disposed in an opening 24 within side wall 25. Drawer 23 may comprise a drawer surface 26 one or more positioning tabs 27, a drip cup 28 and a drawer face 29. One or more heat sources 21 may be loaded onto drawer surface 26 using positioning tabs 27 to align them on drawer surface 26. Drawer 23 can then be slid into base unit 20 in the direction of arrow 201 such that the one or more heat sources 21 are disposed within recess 22 in a desired configuration. In order to fully slide Drawer 23 into base unit 20, a gravity lock (not shown) must be overcome by lifting drawer handle 200 slightly during sliding. The gravity lock (not shown) serves to hold the drawer closed until drawer handle 200 is once again lifted, allowing drawer 23 to be slid out of base unit 20. When drawer 23 is completely slid into base unit 20, drawer face 29 serves to cover opening 24. Further, a top surface 207 has a top opening 208, and a bottom surface 209 has bottom vents 210. In some embodiments, drawer 23 slides along a track (not shown) which is disposed on bottom surface 209.

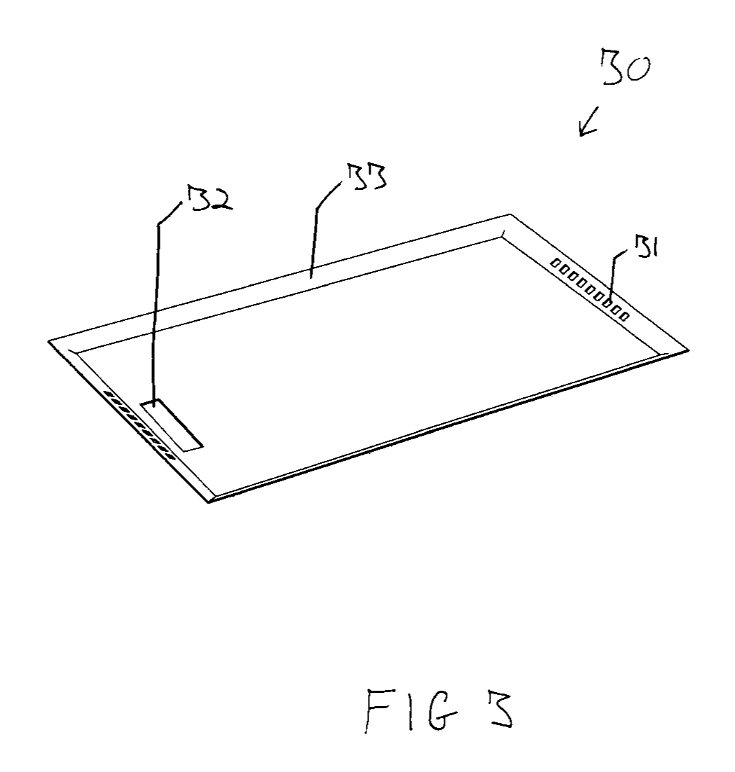

FIG. 3 illustrates an overview of a grill module 30 according to an embodiment of the invention. Grill module 30 is made of a thermally conductive material such as stainless steel. Grill module 30 may include vents 31 and/or drain hole 32, and a grill lip 33. In other embodiments, grill module 30 may omit drain hole 32 to be used as a serving tray module (not shown).

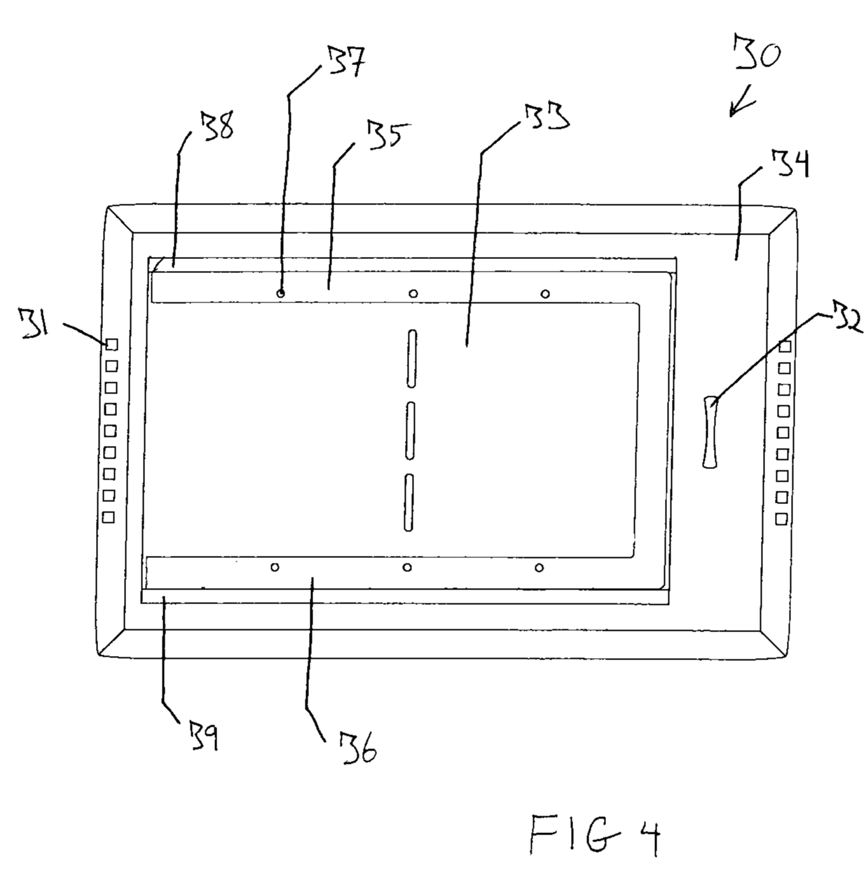

FIG. 4 illustrates an underside view of grill module 30 according to an embodiment of the invention. Grill module 30 may include vents 31 and/or drain hole 32. In some embodiments, grill module 30 also includes thermal pad 33. Thermal pad 33 may be made of aluminum or another suitable thermally conductive material, and in some embodiments may be thermally connected to the underside 34 of grill module 30 using a suitable thermal putty (not shown) known in the art. Thermal pad 33 can have the advantage of providing even heating to the underside 34 of grill module 30 and avoiding “hot spots” when grill module 30 is heated from below. Longitudinal stiffeners 35 and 36 may be constructed of aluminum and take the form of a perpendicular flange, or other suitable geometry. In some embodiments, longitudinal stiffeners 35 and 36 are formed as one piece with thermal pad 33. Longitudinal stiffeners 35 and 36 can have the advantage of preventing warping of grill module 30 due to the uneven thermal expansion rates of its components. In some embodiments, tracks 38 and 39 are attached to the underside of grill module 30 using studs 37. Tracks 38 and 39 can be used to slidably connect one or more electric heating units (not shown) of a type known in the art to the underside of grill module 30.

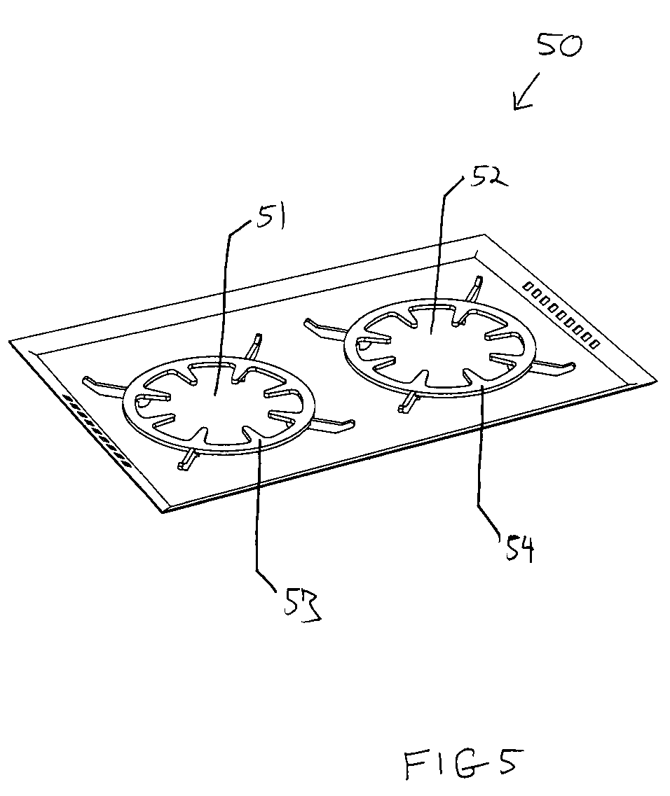

FIG. 5 illustrates an overview of a grate module 50 according to an embodiment of the invention. Grate module 50 is of a similar construction to grill module 30. Grate module 50 is constructed similarly to grill module 30 as shown in FIG. 3, except in that it includes two grate openings 51 and 52, and grates 53 and 54.

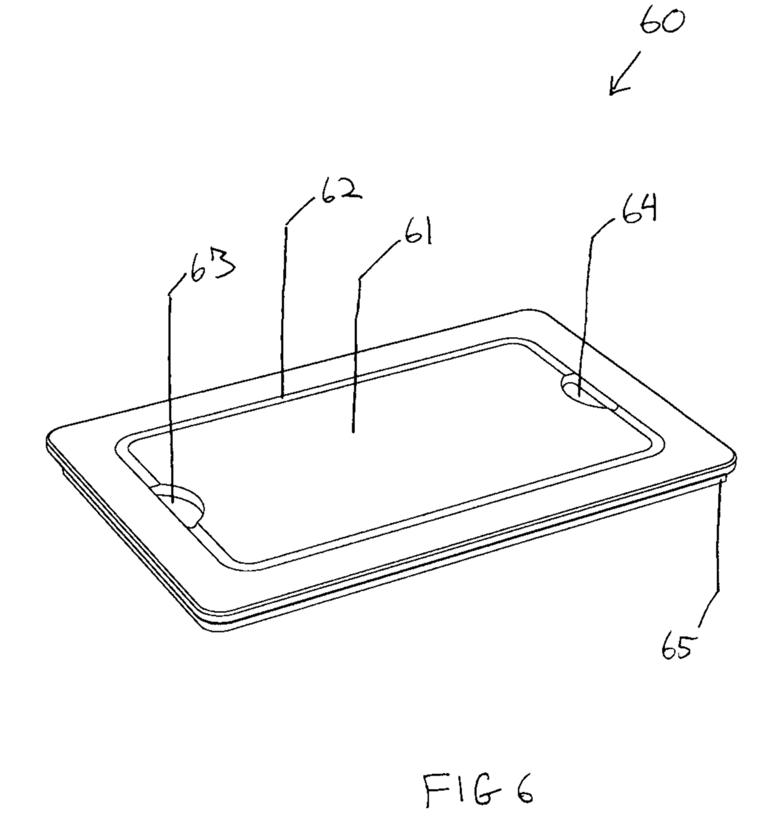

FIG. 6 illustrates a carving board module 60 according to an embodiment of the invention. Carving board module 60 is made of a material which is suitable for use as a cutting board, such as a high density polyethylene plastic (HDPE), an acrylic polymer such as Corian™, or another suitable material known in the art, and has a cutting surface 61. Carving board module 60 may also comprise gutter 62, and/or scrap holes 63 and 64, and lip 65, which is used for integration with other components of the system (not shown).

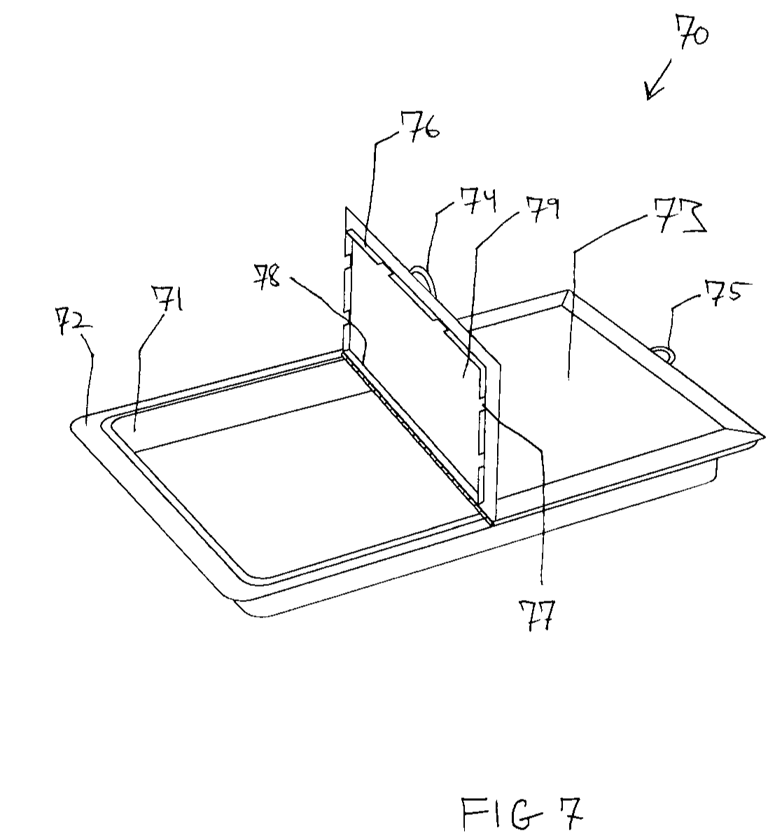

FIG. 7 illustrates an overview of a pan module 70 according to an embodiment of the invention. Pan module 70 is made of a thermally conductive material such as stainless steel or another suitable material. In some embodiments, pan module 70 may have an inner pan 71 and an outer pan 72. Hinged lid 73 is shown covering pan module 70, and can be used to cover pan module 70. Hinged lid 73 can include handles 74 and 75 as well as a venting surface 76 which contains steam vents 77 and condensation channel 78. In this embodiment, when hinged lid 73 is closed, steam can escape the tray via steam vents 77. When handle 74 is lifted to open hinged lid 73, any condensation (not shown) which has accumulated on underside surface 79 of hinged lid 73 will slide down the underside surface 79 toward condensation channel 78 due to gravity, where it will collect and flow into outer pan 72. This can have the advantage of preventing food contained within inner pan 71 from becoming waterlogged due to the accumulation of condensation.

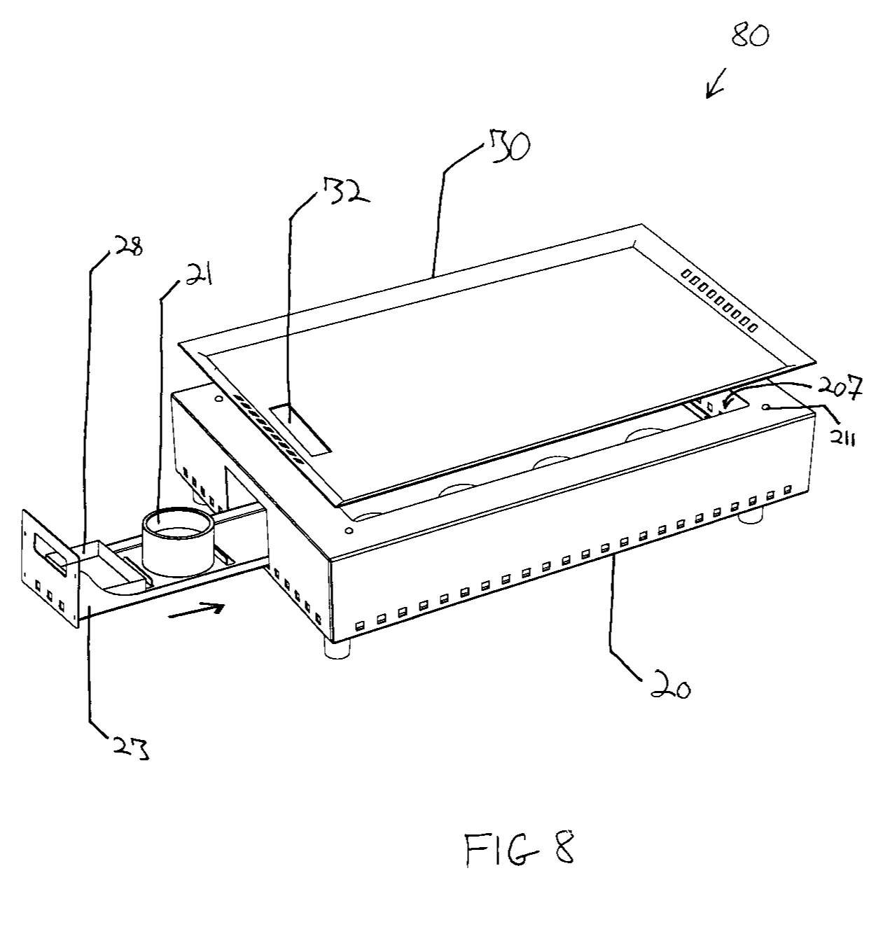

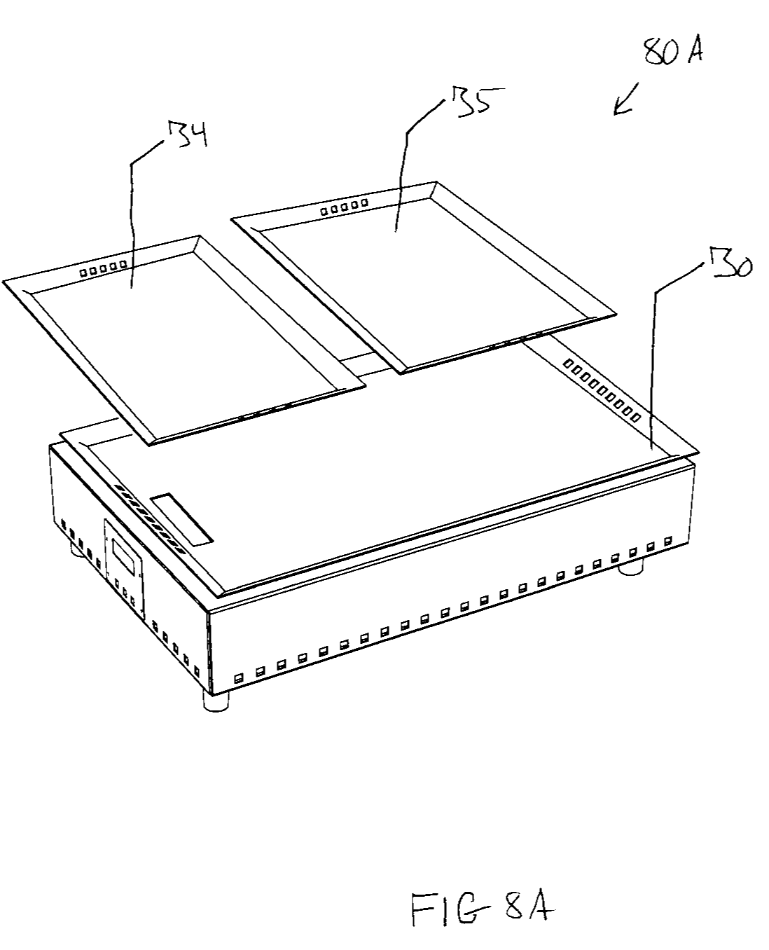

FIG. 8 illustrates an exploded view of an example assembly 80 of grill module 30 with base unit 20. Grill module 30 is constructed such that it has a shape complimentary to base unit 20. The complimentary shape of grill module 30 allows it to be placed atop base unit 20 such that grill module 30 is removably seated within recess 207, and rested upon pads 211 When grill module 30 is assembled with base unit 20 and drawer 23 is in the closed position, drip cup 28 is positioned directly below drain hole 32. During cooking on the grill module 30, grease (not shown) can be deposited into drain hole 32, where it will collect in drip cup 28. Subsequently, drawer 23 can be opened periodically to remove and empty drip cup 28 without disturbing any of the rest of the assembly. If required, heat source 21 can also be replaced at this time. This demonstrates an advantage of the system, where for example, buffet staff can maintain the equipment without disassembling the food service, and with a minimum of disruption to clientele.

FIG. 8A illustrates an exploded view of an example assembly 80A which includes two serving tray modules 34 and 35, which in some embodiments may be ½ the size of grill module 30 and can be seated directly atop grill module 30.

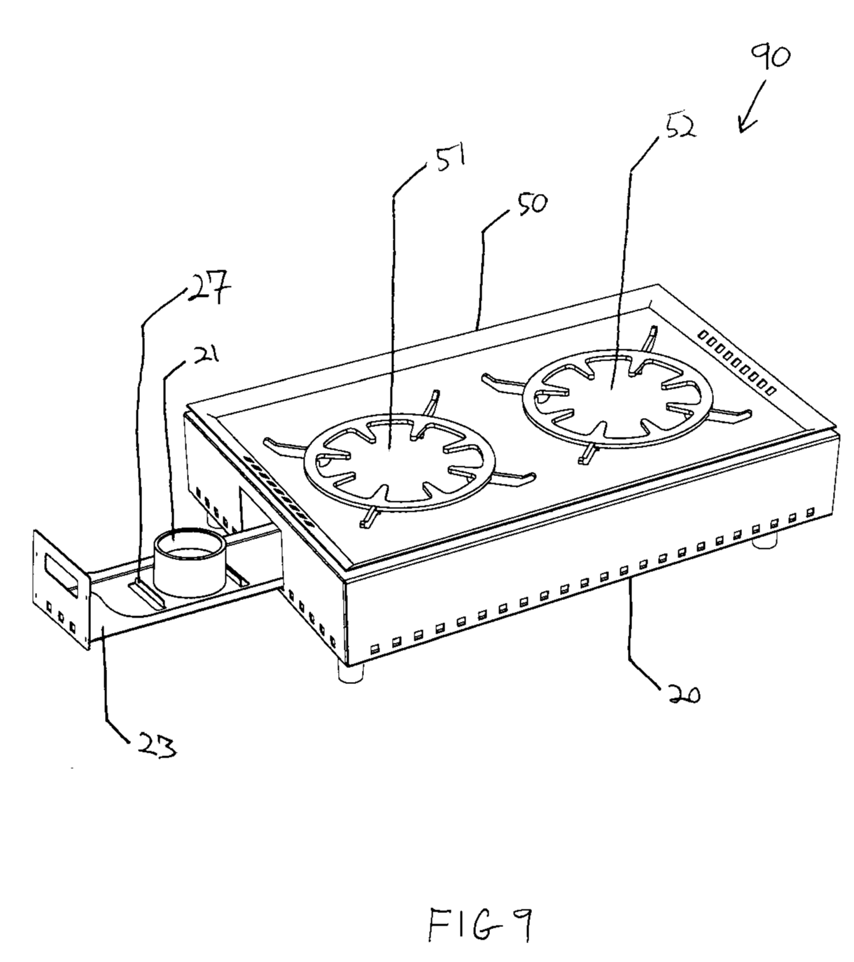

FIG. 9 illustrates an example assembly 90 of grate module 50 with base unit 20. Here, positioning tabs 27 are aligned such that heat sources 21 are positioned directly beneath grate openings 51 and 52 when drawer 23 is in the closed position.

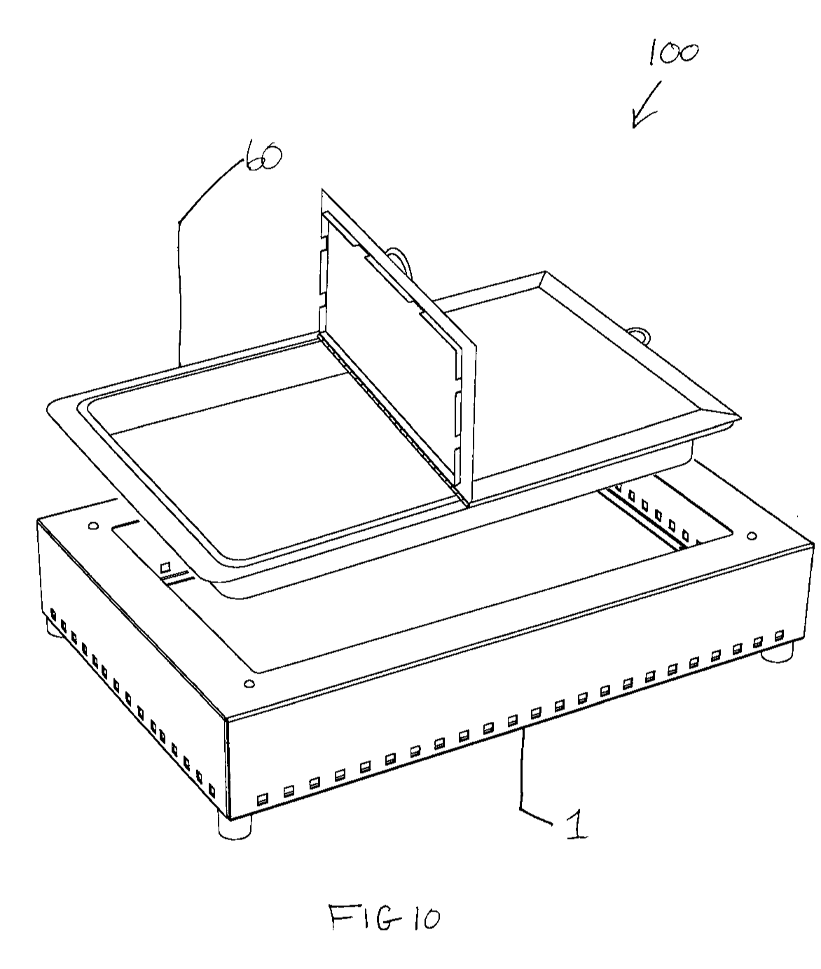

FIG. 10 illustrates an exploded view of an example assembly 100 of pan module 60 with base unit 1.

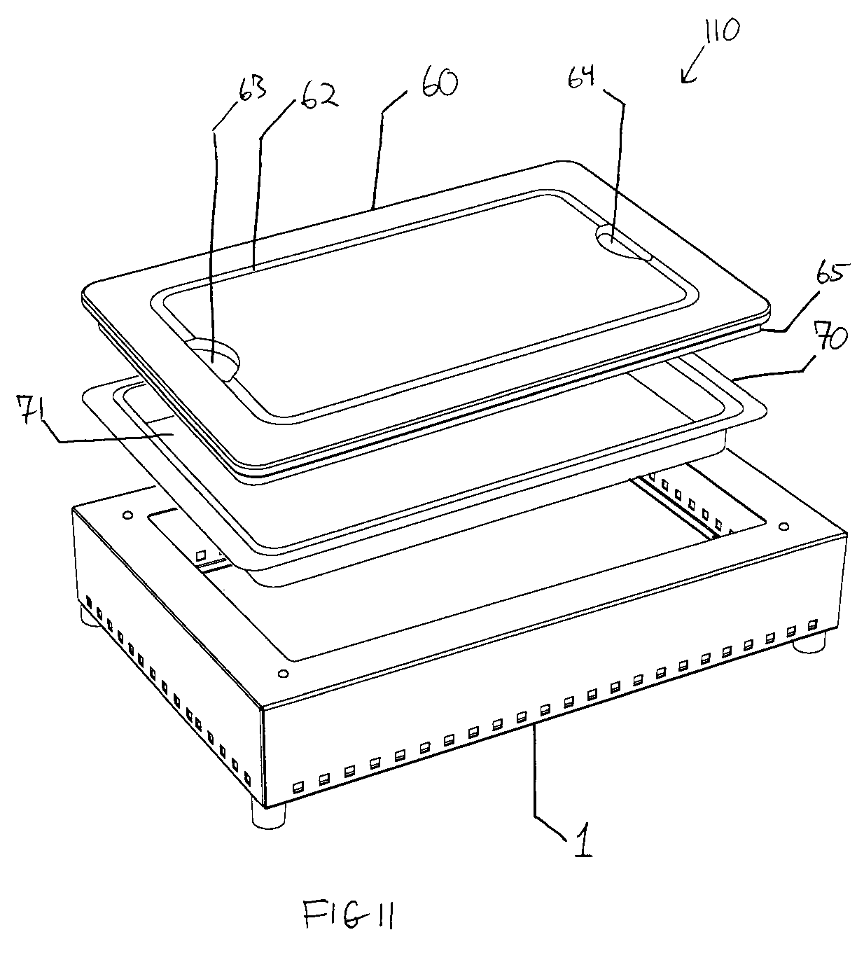

FIG. 11 illustrates an exploded view of an assembly 110 of carving board module 60 and pan module 70 with base unit 1. In this embodiment, pan module 70 is seated atop base unit 1, and carving board module 60 is seated atop pan module 70. Lip 65 is shaped such that carving board module 50 fits into inner pan 71 of pan module 70. During carving, juices and food scraps (not shown) can be maneuvered into gutter 62 and scrap holes 63 and 64 so that they collect out of view in inner pan 71. This assembly demonstrates an aspect of the interchangeability and flexibility that is characteristic of the invention, and can have the advantage of facilitating neat and efficient carving service at a buffet.

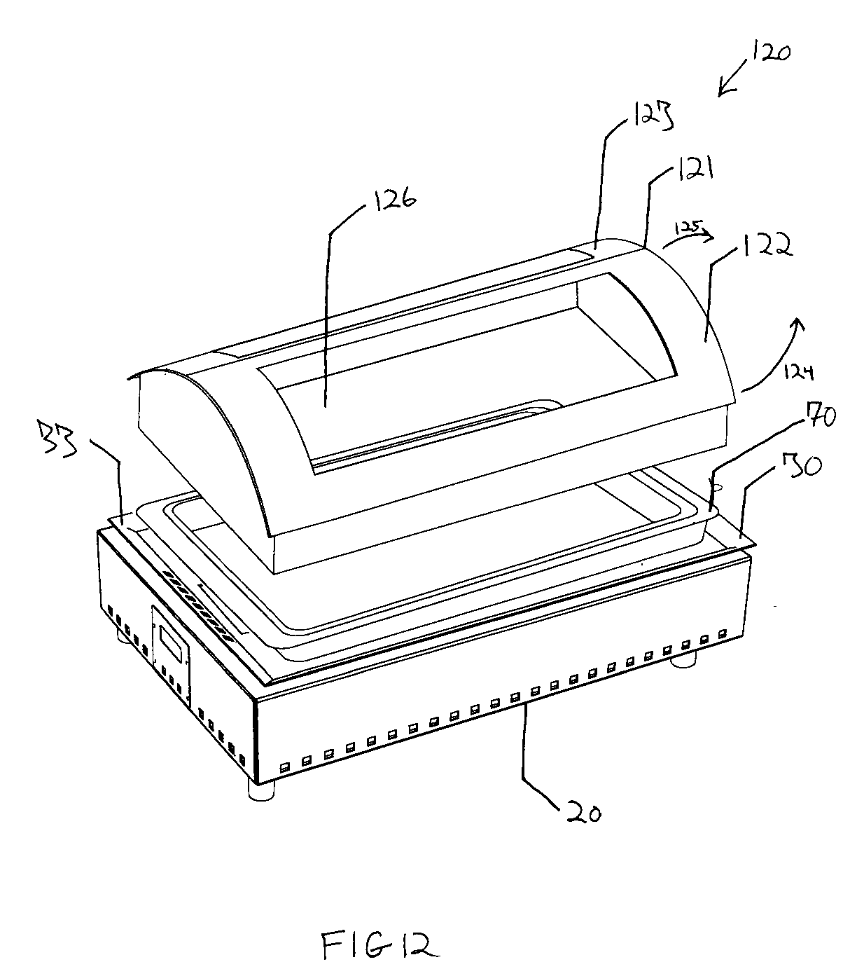

FIG. 12 illustrates an exploded view of assembly 120 of base unit 20, grill module 30, pan module 70, and a dome module 121. Dome module 121 includes one or two hinged lids 122 and 123. In various embodiments, hinged lid 122 may be attached to dome module 121 such that it can be opened upwardly as indicated by arrow 124, or outwardly, as indicated by arrow 125. In various embodiments, hinged lid 123 can be opened in the same fashion as hinged lid 122. In some embodiments, one or both of hinged lids 122 and 123 include a window 126. Window 126 may be comprised of tempered glass or another suitable transparent material. Assembly 120 is formed by seating grill module 30 on base unit 20, and resting pan module 70 on grill module 30, while dome module 121 is seated on grill module 30, enclosing pan module 70. Dome module 121 has a shape and dimension such that it seats within grill lip 33 of grill module 30. In this arrangement, assembly 120 allows waterless heating of food, which can have the advantage of avoiding the disadvantages of common chafing dishes such as waterlogged food. In other embodiments, heating elements (not shown) can be omitted, and ice or cold gel packs (not shown) can be placed within pan module 70. In this way, the assembly will allow cooling of food.

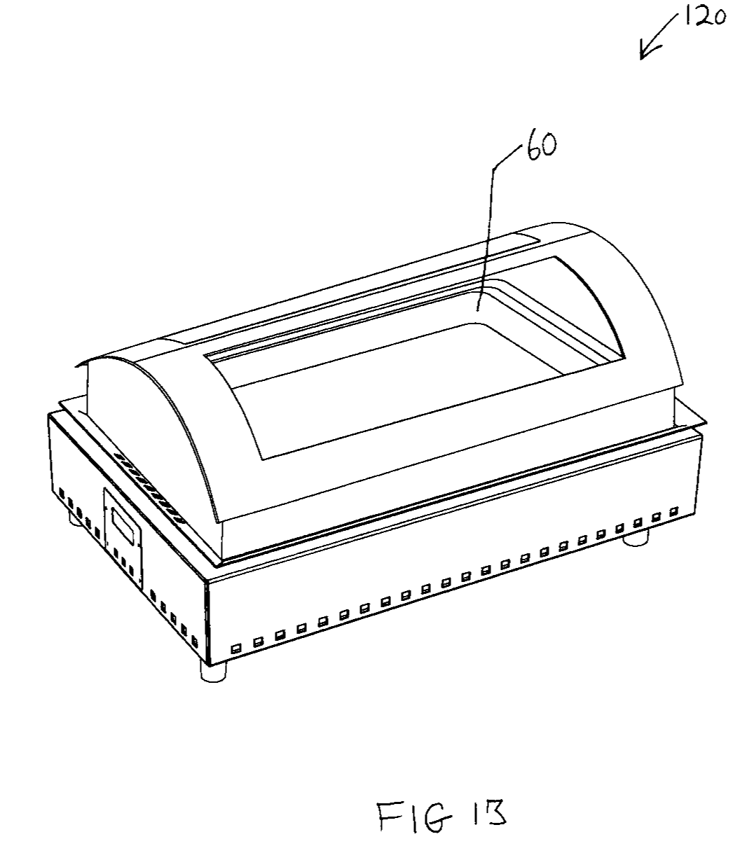

FIG. 13 illustrates completed assembly 120. In other embodiments, pan module 60 may be omitted from assembly 120.

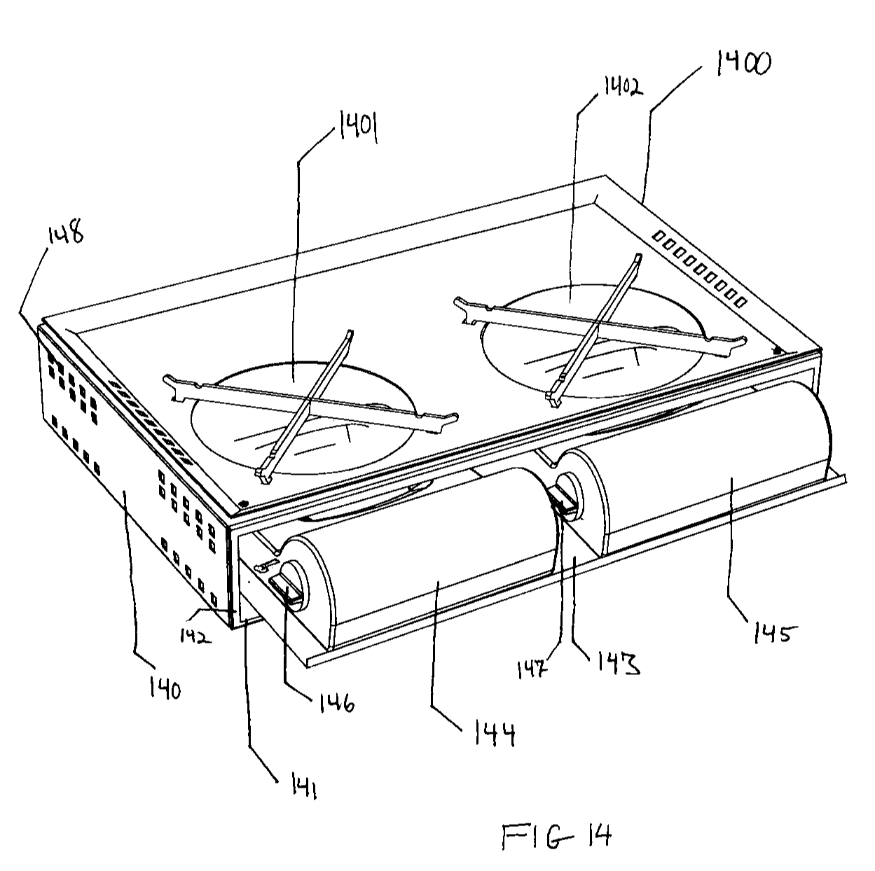

FIG. 14 illustrates an overview of a further embodiment of the invention. Base unit 140 is constructed in a substantially identical fashion to base unit 1 as shown in FIG. 1, except as herein described. Base unit 140 includes an opening 141 in side wall 142. An insertion tray 143 is provided, having a shape and dimensions adapted for insertion into base unit 140 via opening 141. Butane burners 144 and 145 are provided, having shapes and dimensions such that they will fit within base unit 140 via opening 141. Butane burners 144 and 145 can be positioned on insertion tray 143, which can then be slid through opening 141, as partially shown in an operating position. Grate module 1400 is constructed in a substantially similar fashion to grate module 50 shown in FIG. 5 except as herein described, and is seated in a recess (not shown) of base unit 140. Alignment notches (not shown) prevent grate module 1400 from being inserted into base unit 140 in an incorrect orientation. In the operating position shown, the butane burners 144 and 145 are aligned with grate 1401 and 1402 of grate module 1400, which permits the use of the assembly as a cooktop. Controls 146 and 147 of burners 114 and 115 are also accessible when insertion tray 143 is in the operating position shown, and butane fuel cells (not shown) contained within burners 144 and 145 are also positioned substantially outside of base unit 1400, ensuring that they are not exposed to excessive amounts of reflected heat during operation. In some embodiments, additional vents 148 are provided to reduce the accumulation of reflected heat during operation. It should be understood that in other embodiments, a base unit (not shown) similar to base unit 140 and grate module (not shown) similar to grate module 1400 can be adapted for use with a single burner (not shown), or with additional burners (not shown).

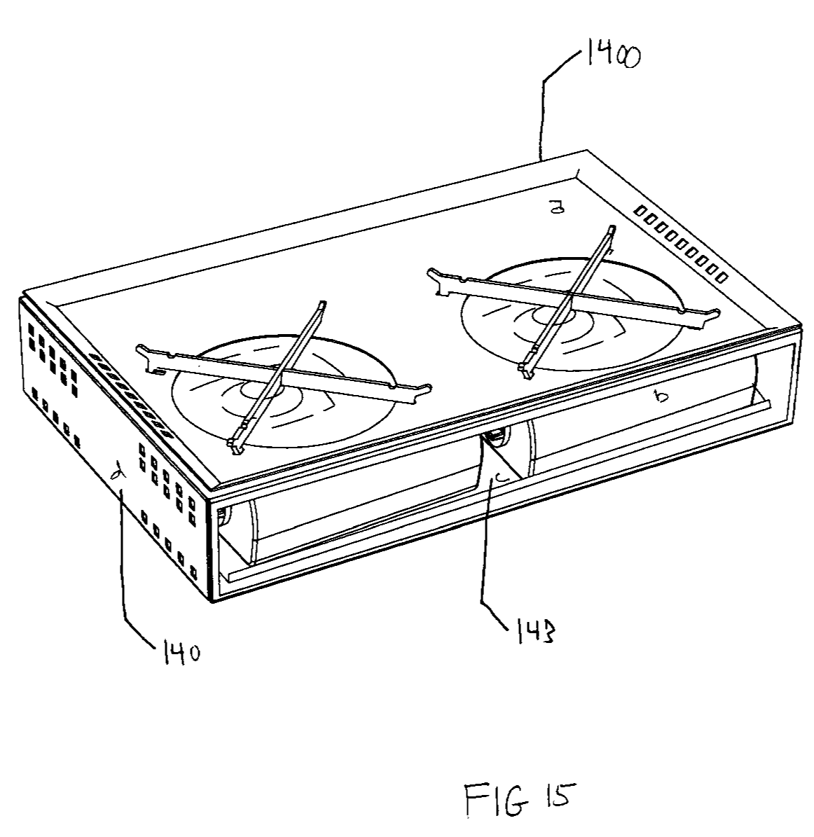

FIG. 15 illustrates an overview of all of the components shown in FIG. 11, after the insertion tray 143 has been fully slid into a storage position within base unit 140. In this configuration, butane burners 114 and 115 are shielded from accidental jarring within base unit 140.

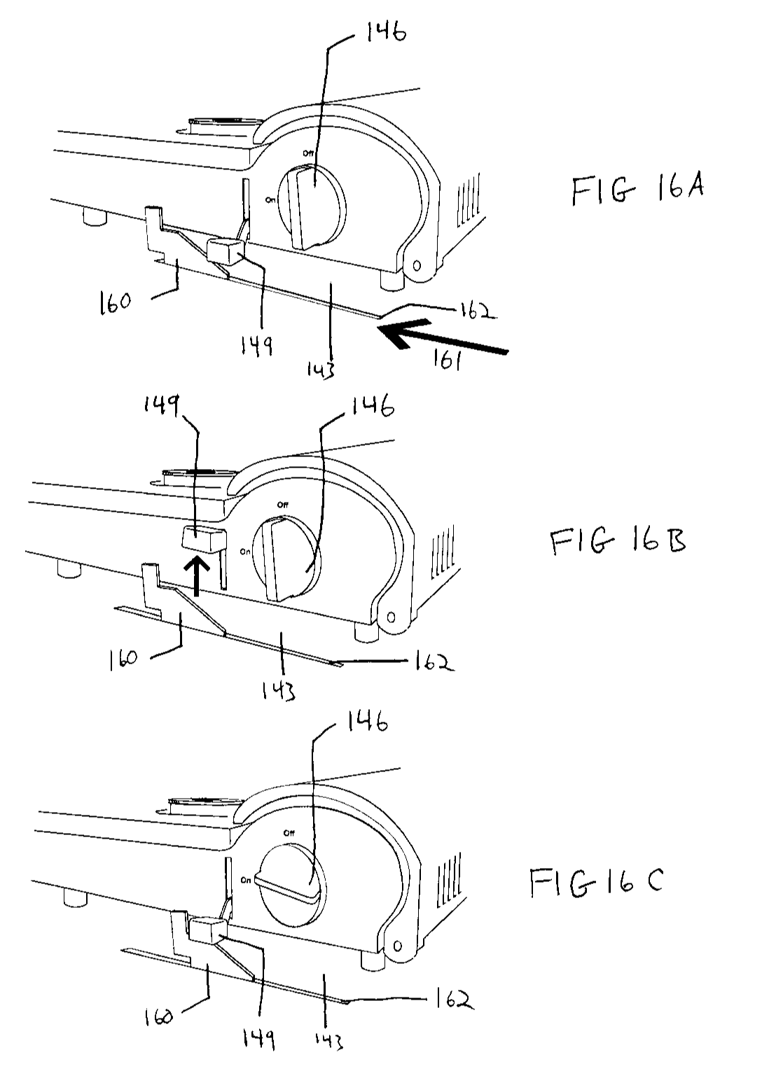

FIGS. 16 A-C illustrate the operation of safety tab 160. Safety requires that when insertion tray 143 is slid in the direction of arrow 161 into base unit 140 from an operating position as shown in FIG. 14 to a storage position as shown in FIG. 15, control 146 and shutoff 149 must be in the off positions. Safety tab 160 is attached to the interior of base unit 140 (FIGS. 14 and 15) and in some embodiments may protrude through a slot 162 in insertion tray 143. Safety tab 160 is disposed in such a way that if either control 146 or shutoff 149 are not in the off position, Safety tab 160 will trip shutoff 149 into the off position and/or prevent full insertion of insertion tray 143 by blocking control 146.

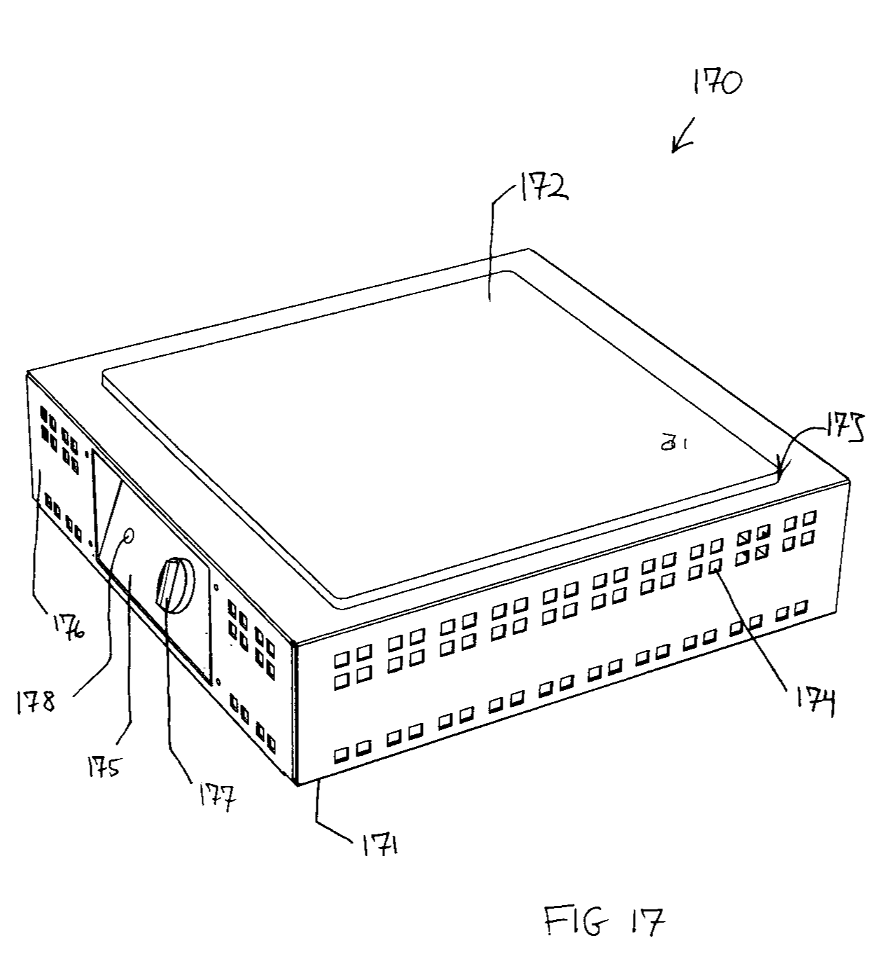

FIG. 17 illustrates an overview of an induction cooktop assembly 170 according to an embodiment of the invention. Induction cooktop assembly 170 has a base unit 171 and an induction heating unit 172. Base unit 171 may be constructed in a substantially identical fashion to base unit 1 as shown in FIG. 1, except as herein described. Induction heating unit 172 is adapted to fit within recess 173 of base unit 171, and can be of a standard type known in the art. Base unit 171 may have additional vents 174 as well as control recess 175. Control recess 175 is disposed within a side wall 176 of base unit 171, and has control 177. In some embodiments, Control recess 175 has indicator 178. Indicator 178 may be used to indicate the power or heat condition of induction heating unit 172. Control 177 is used to regulate the operation of induction heating unit 172, and in some embodiments, control 177 is angled upward from the vertical. This can have the advantage of making control 177 simultaneously visible and easily operable by buffet staff who are standing.

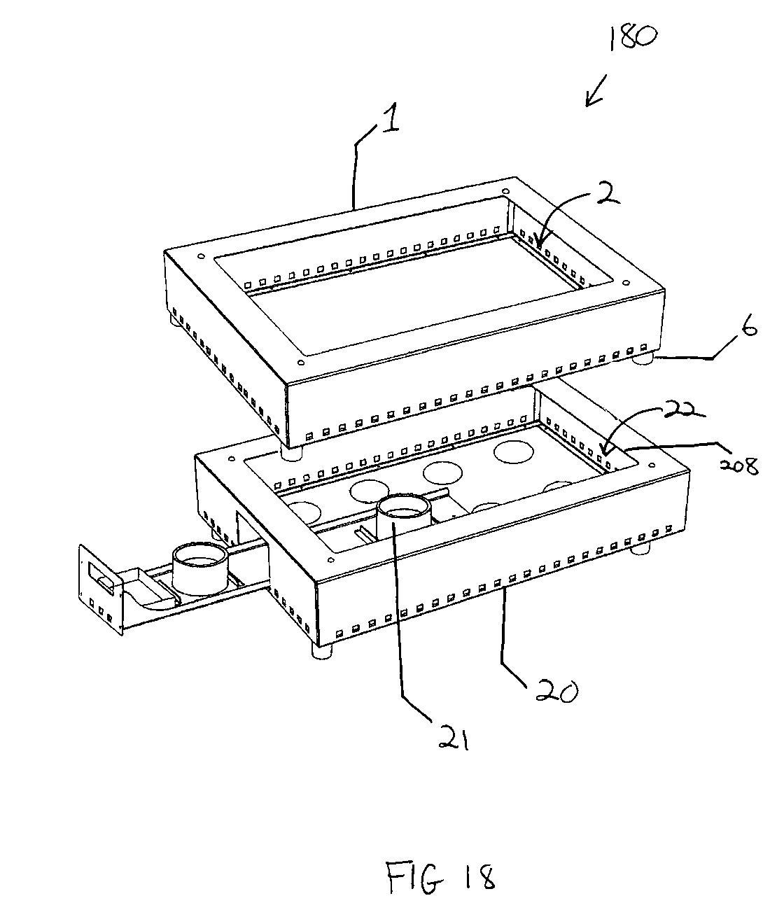

FIG. 18 illustrates an exploded view of an assembly 180 of base unit 1 with base unit 20. In this configuration, base unit 1 provides additional height to the assembly, and functions as a riser. Because heat source 21 is present in base unit 20, base unit 1 is heated from below, while leaving space in recess 2 for further assembly with a module (not shown). For instance, pan module 70 as shown in FIG. 7 could be inserted into recess 2, or an alternate module (not shown) which is substantially similar to pan module 70 (FIG. 7) but having a greater depth could be inserted into recess 2. Furthermore, this arrangement can have the advantage of providing indirect heat to a module (not shown) inserted into recess 2. Feet 6 are sized and arranged on base unit 1 so that they fit into recess 22, just within the perimeter of top opening 208, in order to lock base unit 1 into place atop base unit 20.

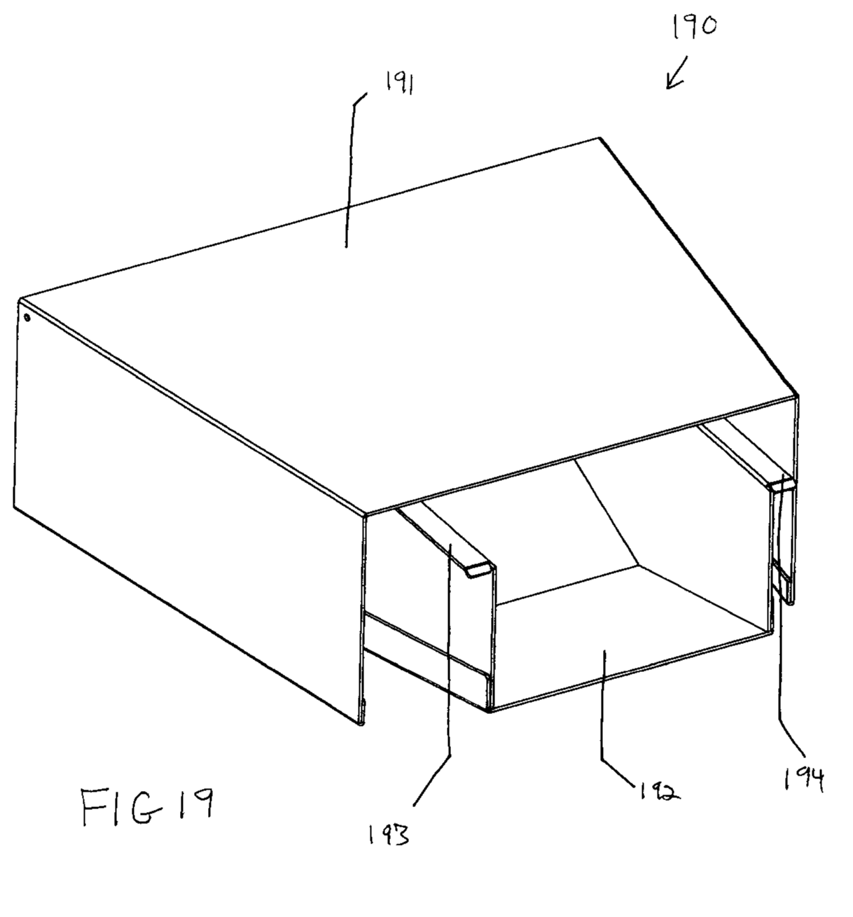

FIG. 19 illustrates an overview of wedge riser module 190. Wedge riser module 190 can be used to join base units such as base unit 1 (FIG. 1) to other base units (not shown) to create an arc or serpentine arrangement of cooking stations (not shown). Wedge riser module 190 includes wedge riser 191 and in some embodiments includes caddy 192. Wedge riser 191 and caddy 192 may be made of stainless steel or other suitable materials. Caddy 192 includes caddy flanges 193 and 194, which can be slidably engaged with tracks (not shown) disposed on the underside of wedge riser 191. This allows caddy 192 to be slid under wedge riser 191 in the manner of a drawer. This can have the advantage of providing a neat and sanitary location for the storage of serving implements such as forks, spoons, tongs, and plates (not shown). In another embodiment, wedge riser module 190 can be rectangularly shaped to form a rectangular riser (not shown), which is otherwise similarly constructed and can be used to join base units such as base unit 1 (FIG. 1) to other base units (not shown) in a straight fashion.

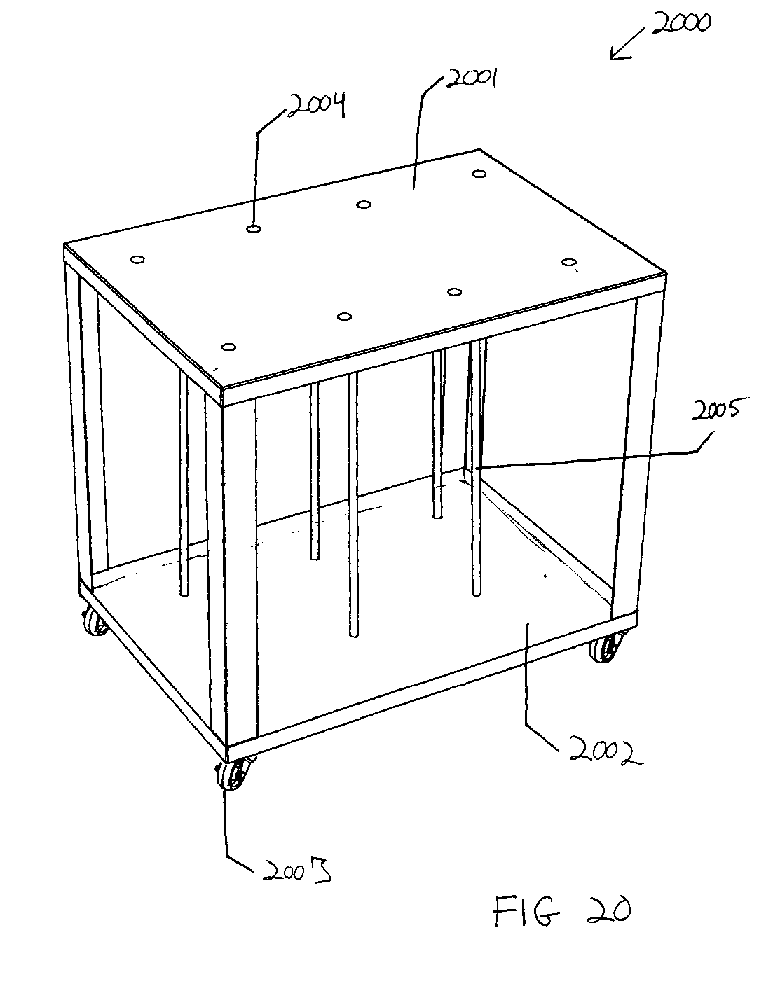

FIG. 20 is an overview of a storage unit 2000. In some embodiments, storage unit 2000 has the general form of a cart, and includes a top deck 2001, bottom deck 2002, and wheels 2003. Top deck 2001 contains holes 2004. Holes 2004 have a dimension and spacing which corresponds to the feet of various base units such as feet 5 of base unit 1, as shown in FIG. 1. The various base modules (not shown) can be stored on top deck 2001 by inserting the feet (not shown) of the base modules (not shown) into holes 2004. Successive layers of base modules (not shown) can be stacked, such that they interlock in the manner described with respect to FIG. 18. In some embodiments, this enables up to 8 base units (not shown) to be stored on storage unit 2000. Because of this interlocking structure, storage unit 2000 can be rolled with more stability than would be possible with simple stacking of base units (not shown). Partition rods 2005 are positioned vertically between top deck 2001 and bottom deck 2002. Partition rods may be made of stainless steel or another suitable material, and may be covered with a coating (not shown) made of transparent PVC plastic, or another suitable material. Partition rods 2005 are disposed and arranged to provide a storage location for various modules of the invention. Bottom deck 2002 comprises drain holes (not shown). The arrangement of partition rods 2005 and the drain holes can have the advantage of allowing modules (not shown) stored on bottom deck 2002 under top deck 2001 to be sprayed clean such that excess moisture drains off of the module surfaces (not shown) and out through the drain holes.

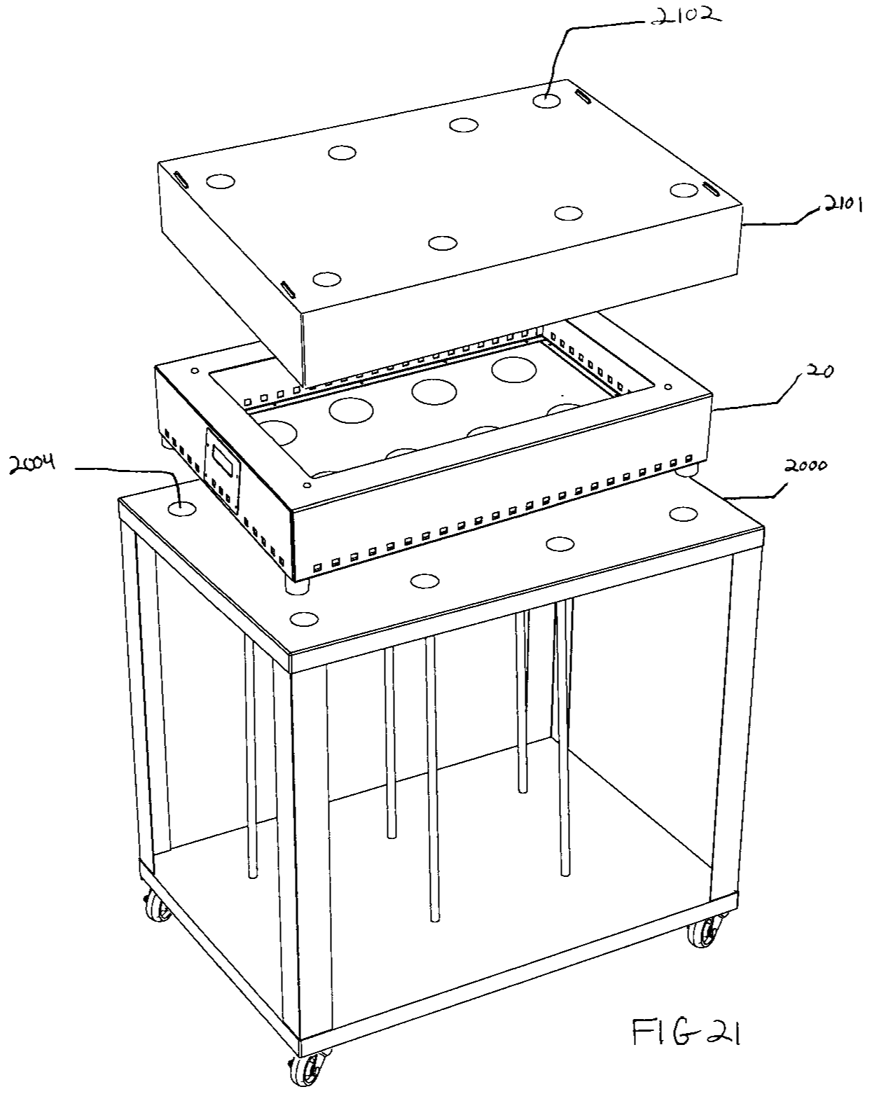

FIG. 21 is an exploded view of a storage assembly 2100. Storage assembly 2100 includes storage unit 2000, base unit 20, and a cover 2101. Cover 2101 is made of corrugated plastic or another suitable material, and has a shape and dimensions such that it fits over base unit 20. Cover 2101 can have dimensions and shapes calculated to fit over any of the various base units (not shown) that may embody the invention. Cover 2101 has holes 2102 that are arranged in the same manner as holes 2004, such that additional base units (not shown) can be stacked in the manner described with respect to FIG. 20 while base unit 20 is covered.

What is claimed is:

1. A buffet serving system comprising:
at least one base having a recess therein; and
a plurality of modules each receivable in the recess of the base and having an outer surface adapted for at least one of cooking and serving of food;
wherein at least one of the plurality of modules has a different configuration than the other modules.

2. The buffet serving system of claim 1, wherein the number of modules is greater than the number of bases.

3. The buffet serving system of claim 1, wherein at least one of the plurality of modules is thermally conductive.

4. The buffet serving system of claim 1, wherein at least one outer surface of the plurality of modules comprises an induction cook top.

5. The buffet serving system of claim 1, wherein at least one outer surface of the plurality of modules comprises grates.

6. The buffet serving system of claim 1, wherein the base further comprises a heat source removably positioned in the recess of the base and below the module receivable in said recess of said base.

7. The buffet serving system of claim 6, wherein the heat source is sterno.

8. The buffet serving system of claim 6, wherein the heat source is electric.

9. The buffet serving system of claim 6, wherein the heat source is butane.

10. The buffet serving system of claim 1, wherein at least one of the plurality of modules is a carving board.

11. The buffet serving system of claim 1, wherein the base has a side wall having at least one drawer therein.

12. The buffet serving system of claim 1, wherein at least one of the plurality of modules is a chafing system comprising a serving pan receivable in a water pan.

13. The buffet serving system of claim 13, wherein the chafing system further comprises a hinged lid having a condensation channel therein.

14. The buffet serving system of claim 1, wherein the base has at least one corner, and further comprising at least one guard for receiving the corner of the base.

15. A buffet serving system comprising:
at least one base having a recess therein;
a plurality of modules each receivable in said recess and adapted for at least one of cooking or serving of food; and
at least one riser having a top planar surface with at least one side panel extending therefrom, said side panel having an opening therein;
wherein at least one of the plurality of modules has a different configuration than the other modules and the number of modules is greater than the number of bases.

16. The buffet system of claim 16, further comprising a storage caddy receivable in the opening of the side panel of the riser.

17. The buffet system of claim 16, wherein the plurality of modules comprises at least one carving board, at least one chafing system, and at least one cooking element selected from grill, induction top, and sauté cooker.

18. The buffet system of claim 17, wherein the plurality of modules further comprises at least one display tray.

19. A buffet serving system comprising:
at least one base having a recess therein;
a plurality of modules each receivable in said recess and adapted for cooking or serving of food; and
a cart having wheels for storage and transport of said base and said plurality of modules
wherein at least one of the plurality of modules has a different configuration than the other modules and the number of modules is greater than the number of bases.

20. The buffet serving system of claim 18, further comprising at least one protective case for receiving said base or said modules.
